(19) United States
(12) Patent Application Publication
(10) Pub. No.: US 2009/0028397 A1
(43) Pub. Date: Jan. 29, 2009

(54) MULTI-SCALE FILTER SYNTHESIS FOR MEDICAL IMAGE REGISTRATION

(75) Inventor: Sherif Makram-Ebeid, Dampierre (FR)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/718,448

(22) PCT Filed: Oct. 25, 2005
(86) PCT No.: PCT/IB05/53493

§ 371 Date: May 2, 2007

(30) Foreign Application Priority Data
Nov. 5, 2004 (EP) 04300763.2

(51) Int. Cl. G06K 9/00

(52) U.S. Cl. 382/128

(57) ABSTRACT

First and second images to be registered are filtered using a low-pass filter kernel having a sharp central peak and a slow decay away from the central peak. The apparatus determines a mapping function that transforms the filtered first image into the filtered second image.

The present invention generally relates to image registration. More specifically, the present invention addresses an effective registration technique for matching digital images, particularly medical images, with high accuracy, computational efficiency and reliability.

Image registration is the process of overlaying two or more images of the same scene taken at different times, from different viewpoints, and/or by different sensors. It geometrically aligns the contents of at least two images referred to as the reference image and the sensed image. A general registration formulation can be stated as: given two shapes, an input D (in the sensed image) and a target S (in the reference image), and a dissimilarity criterion, find the best spatial transformation T that associates to any point of D a corresponding point in S, and that minimizes the dissimilarity criterion between the transformed shape Δ=T(D), and the target S. The dissimilarity criterion can be defined either along the contours of the shapes Δ and S (feature-based registration) or in the entire region determined by these contours (area-based registration).

Image registration is a crucial step in all image analysis tasks in which the final information is obtained from the combination of various data sources. Typically, registration is required in remote sensing, environmental monitoring, weather forecasting, . . . . In medicine, it can be used for example to combine computer tomography (CT) and nuclear magnetic resonance (NMR) data to obtain more complete information about the patient such as monitoring tumor growth, verifying treatment efficiency, comparing the patient's data with anatomical atlases, . . . .

In “Image registration methods: a survey” by Barbara Zitova and Jan Flusser, Image and Vision Computing 21 (2003) p. 977-1000, a large number of registration methods were reviewed. Most methods include the following stages:
Feature detection: salient and distinctive objects (closed-boundary regions, edges, contours, line intersections, corners, etc.) are manually or, preferably, automatically detected. This stage is of a crucial importance as it can affect significantly the performance of the selected registration algorithm;
Feature matching: a correspondence is established between specific features detected in the sensed image and pixels detected in the reference image that are supposed to represent the same features;
Transform model estimation: a transformation, often called a mapping function, that matches the sensed image to the reference image, is estimated. The mapping function is defined over an image domain Ω that is common to both images. The parameters of the mapping function are computed using the previously established feature correspondence. This stage can require extensive computational time, especially when the contents in the images to be registered have experienced non rigid motions. This can be linked for example to a deformation (as opposed to a simple translation or rotation) of the objects in the images, and/or to the different viewpoints. The mapping function can be evaluated using the optimization of a dissimilarity function, also called an objective function;
Image resampling and transformation: the sensed image is transformed by means of the mapping function using appropriate interpolation techniques.

In some methods, the second and third stages are merged into a single step.

In “Non rigid registration using distance functions”, Computer Vision and Image Understanding, pp. 142-165, 2003, N. Paragios et al. disclose applying a distance transform to the detected features prior to the merged feature matching and transform model estimation stages, in order to improve registration. This distance transform, also called distance map DM(x,y), is defined as:

$${Φ}_{C} ( x , y ) = \{ \begin{matrix}0 & ( x , y ) ∈ C \\ + DM ( ( x , y ) , C ) & ( x , y ) ∈ {R}_{C} \\ - DM ( ( x , y ) , C ) & ( x , y ) ∈ Ω - {R}_{C}\end{matrix}$$

where C is a given feature in the image domain Ω, R_{C} is the convex hull of C, and DM((x,y),C)) is the minimum Euclidean distance between a grid location (x,y) and the feature C.

When using a gradient descent method to minimize the dissimilarity criterion, the distance transform provides a convenient feature space as it allows a large capture range (distance over which similar features can be compared) and localization accuracy.

Nevertheless, the use of distance transforms, although promising, has some shortcomings. In particular, it requires the extraction of features (first step) from the image, which is not always possible to do in a reliable manner. Furthermore, the extraction of a distance map (function ED) is a non-linear image processing operation, which is known to be sensitive to noise.

An object of the present invention is to provide a method that avoids the shortcomings of the distance transform while keeping the advantages of large capture range and localization accuracy.

Accordingly, the present invention provides an apparatus according to claim 1, a method according to claim 11 and a computer program product according to claim 17.

The invention takes advantage of a specific filter kernel type that ensures local accuracy while maintaining a large capture range for the registration method. Such a filter kernel presents a sharp peak around its center and behaves substantially like an exponential decay or inverse power law with increasing distances away from the kernel's origin. Filtering both the sensed and reference images with such a filter kernel provides a good compromise between keeping the details of the features to be registered together and blurring them sufficiently to allow a large capture range.

Other features and advantages of this invention will further appear in the hereafter description when considered in connection to the accompanying drawings, wherein:

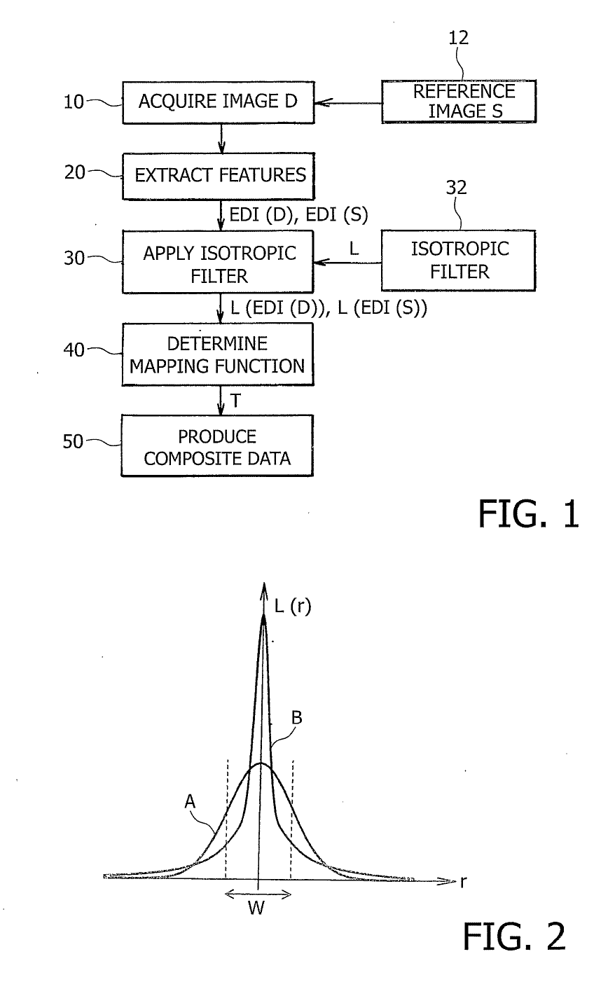

FIG. 1 is a flow chart of a registration method according to the invention;

FIG. 2 is a graph representation of different filter kernels;

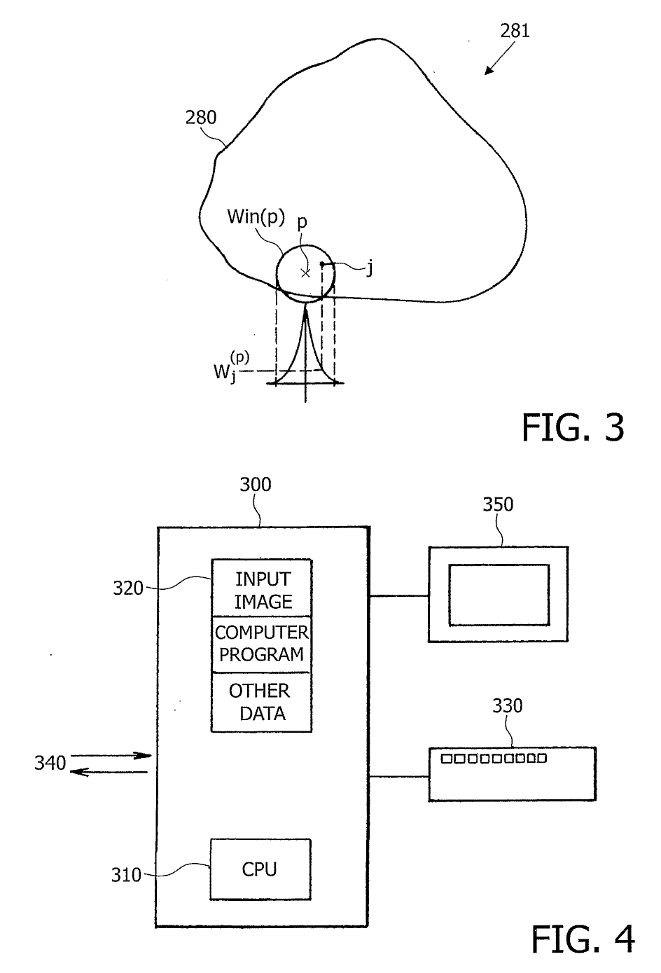

FIG. 3 is a schematic illustration of a convolution of a sensed image features with a filter kernel used in the present invention; and

FIG. 4 is a schematic illustration of a general-purpose computer programmed according to the teachings of the present invention.

The present invention deals with the registration of two or more images. Although the present invention is illustrated in a software implementation, it may also be implemented as a hardware component in, for example, a graphics card in a computer system.

In the following description, reference is made to only two images to be registered together. The invention can be easily extended to a large number of initial images by a person skilled in the art of image processing.

Referring now to the drawings, and more particularly to FIG. 1 thereof, a schematic diagram of the registration method according to the invention is shown. The overall scheme includes an initial step 10 consisting of the acquisition of a medical 2D or 3D image D, or sensed image, to be registered with an reference image S retrieved in step 12. The input image S was itself either acquired before or is taken from a data bank for example. If necessary, initial step 10 may include a digitization of one or both of the images.

In an optional second step 20, features are detected in the images D and reference S. This provides feature-enhanced images EDI(D) and EDI(S). The detected features can be edges of objects depicted in the images (EDI(D) and EDI(S) are then called edge-detected images as in the following description). They can also consist of ridges, or of central lines of tubular objects such as, e.g., blood vessels.

A feature-enhanced or edge-detected image is created using techniques known in the art, such as the local variance method. A source image is subjected to edge detection so that the contours of objects it contains are detected. Thus, the pixel values in the edge-detected image account for the features in the region of interest (ROI) in the source image. They denote a feature saliency quantity which can be either the pixel intensity values, a local gradient in pixel intensity, or any suitable data related to the feature intensity in the source image.

This second step remains optional as the filter kernel used in the registration method according to the present invention, and described later on, is accurate enough to avoid the need to extract features.

In a third step 30, an isotropic low pass filter L is applied to the edge-detected images EDI(D) and EDI(S), or to the sensed D and reference S images. The distance map of the known registration method, which is results from a non-linear operation, is replaced by a linear convolution.

This operation requires an isotropic filter kernel 32. The general shape of such a kernel is illustrated by curve B in FIG. 2. Such a filter kernel must display a sharp central peak, with a relatively slow decay further away, in order to combine local accuracy and sharpness, and a large capture range. Away from the origin, the filter kernel may behave like an exponential decay or inverse power law of r, the distance to the kernel center.

Curve A in FIG. 2 shows the kernel of an isotropic Gaussian filter, quite conventionally used in image analysis. It is not so sharp as kernel B at the origin, and it also decays more rapidly at large distances. In FIG. 2, curves A and B depict isotropic filter kernels whose peaks have the same effective width

$$W = \sqrt{\frac{{\sum }_{r} {r}^{2} \cdot L ( r )}{{\sum }_{r} L ( r )}} .$$

The central sharpness vs. slow decay feature of the isotropic filter kernel L(r) used is some embodiments of the invention and may be quantized as follows: the slope of L(r) at half-width (i.e. at r=±W2) is at least three times larger than that of the isotropic Gaussian kernel A having the same effective width W, while the slope of L(r) at twice the width (i.e. at r=2.W) is at least three times smaller than that of the isotropic Gaussian kernel A having the same effective width W.

Such a sharp filter kernel (displayed on FIG. 2) combined with the filtering implementation of FIG. 3 (described later on) allows to focus on the detected features while “blurring” them at larger distances to enlarge the capture range, thus reducing the sensitivity to noise or errors in the feature extraction. Such a filter kernel introduces a smooth thresholding of the features as opposed to the distance map.

An improved isotropic filter kernel with kernel behaving like exp(−kr)/rⁿ for non-zero distance from the kernel's origin (radius r being the distance from the kernel center) is designed, instead of the classic exp(−r²/2σ²) behavior of Gaussian Filters, n being an integer ≧0. Such kernels are sharp for small distances comparable to a localization scale s of the features, and should be less steep according to the above laws for distances ranging from this scale s up to ηs, where η is a parameter adapted to the image size, typically η≈10. The value of the coefficient k is also adapted to the desired localization scale s.

Such isotropic filter kernels L(r) can be derived as an approximation of a continuous distribution of Gaussian filters (for d-dimensional images, d an integer greater than 1), using a set of Gaussians with different discrete kernel size σ, each kernel being given a weight g(σ). The resulting filter has a kernel equal to the weighted sum of Gaussian kernels:

$$L ( r ) = {\sum }_{σ} g ( σ ) \cdot \frac{{e}^{- {r}^{2} / {σ}^{2}}}{{σ}^{d}} \qquad ( 1 )$$

For computation efficiency, a multi-resolution pyramid is used with one or more single σ Gaussians (recursive infinite impulse responsive or IIR) for each resolution level.

In practice, filtering any image with the above defined kernel may be performed by first filtering it with a multiplicity of standard Gaussian kernels of different sizes σ and then linearly combining the resulting multiplicity of filtered images by giving a weight g(σ).to each individual image filtered with the kernel of size σ.

When applied to the edge-detected images EDI(D) and EDI(S), or to the sensed D and reference S images, each Gaussian filter of variance a is first applied to one of these images to generate an individual filtered image, generating a multiplicity of individual filtered images from the initial image. The resulting filtered image (with above defined kernel) is obtained from a weighted combination of the individual filtered images with the Gaussian filter using the weight g(σ).

Other approaches (more computationally costly) can be used for such filter synthesis (e.g. Fourier domain, based on solving suitable partial differential equations etc.).

An illustration of how such a filter kernel is applied to an edge-detected image can be seen in FIG. 3. The contour 280 of an object 281 (either from the sensed image D or the reference image S) to be registered has been determined. To calculate a filtered image F(p) from the edge detected images L(EDI(D(p))) and L(EDI(S(p))), a window win(p) is defined around pixel p (here the window is circular and p is its center), as well as an isotropic spatial distribution Wj^{(p)} for all pixels j inside win(p). The spatial distribution is maximum at p, and identical for all j pixels belonging to a circle centered on p. Beyond win(p), the spatial distribution is nil. The spatial distribution over win(p) corresponds to the filter kernel of equation (1). The window size of win(p) is function of the parameters chosen for the filter kernel. Thus we have:

$$F ( p ) = {\sum }_{j ∈ win ( p )} ED ( j ) \cdot {W}_{j}^{( p )} \qquad ( 2 )$$

where Wj^{(p)}=L(r) according to (1), with r being the Euclidean distance between pixels j and p, and ED(p) are the pixel value for pixel p in the edge detected image EDI(D) or EDI(S). In general, ED(j)=0 for all pixels j that do not belong to an edge.

The same illustration remains valid when applying the filter kernel L directly to the initial reference and sensed images, i.e. the prior feature extraction is dispensed with.

In a fourth step 40 of the registration method, a mapping function T is determined. Techniques known in the art to determine a mapping function can be used in this step. For example, the mapping function described in the aforementioned article by Paragios et al. can be used.

After selecting a powerful feature space, i.e. the use of a distance map (which is replaced in this invention by a convolution using a specific filter kernel of equation (1)), the mapping function determination includes the integration of global linear registration models (rigid, affine, etc.) and local deformations.

As mentioned before, registration amounts to finding a spatial transformation T between the sensed image D and the reference image S that minimizes over the image domain Ω a given dissimilarity criterion. In Paragios et al., the dissimilarity criterion to be minimized over Ω is:

$$Φ = {\sum }_{p ∈ Ω} {[ D ( p ) - S ( \hat{p} ) ]}^{2} \qquad ( 3 )$$

where: \hat{p}=A(p)+U(p)=T(p);
A is an affine transformation that accounts for rigid deformation between D and S, and includes a rotation, a translation and a scaling factor;
U is a transformation that accounts for the local non-rigid deformation and has values only for the non-rigid parts of the shape to be registered;
T is the mapping function.

An iterative process, such as a gradient descent method, is used to recover the optimal registration parameters.

An improvement over this method consists in introducing slowly varying weights α, β, and γ with the condition α²+β²=1 so as to minimize the value of the following normalized convolution of a modified dissimilarity criterion:

$${Φ}^{′} = {\sum }_{p ∈ Ω} {[ α ( p ) \cdot D ( p ) - β ( \hat{p} ) \cdot S ( \hat{p} ) + γ ]}^{2} \qquad ( 4 )$$

where: α(p) and β(p) are slowly varying weights to account for different scaling factors between images D and S. These weights are normalized, i.e. α²+β²=1. Their determination uses a low-pass filter LP with a relatively large kernel as described hereafter;
γ is an offset value independent of p.

The optimal choice of the weight parameters α and β can be done in a conventional manner by means of the statistical moments of order 1 and 2 of D(p) and S(T(p)). To admit a certain amount of spatial variation of these weight parameters it is proposed to compute locally the statistical moments of order 1 and 2 of D(p) and S(T(p)), by introducing a window win^{LP}(p) centered on each pixel p, over which a spatial distribution W^{LP}(u) corresponding to the above-mentioned low-pass filter kernel LP is defined:

$$\begin{matrix}〈 {M}_{1} ( p ) 〉 = {\sum }_{u ∈ {win}^{LP} ( p )} {M}_{1} ( p + u ) \cdot {W}^{LP} ( u ) , & ( 5 ) \\ 〈 {M}_{1}^{2} ( p ) 〉 = {\sum }_{u ∈ {win}^{LP} ( p )} {M}_{1}^{2} ( p + u ) \cdot {W}^{LP} ( u ) , & ( 6 ) \\ 〈 {M}_{1} \cdot {M}_{2} ( p ) 〉 = {\sum }_{u ∈ {win}^{LP} ( p )} {M}_{1} ( p + u ) \cdot {M}_{2} ( p + u ) {W}^{LP} ( u ) & ( 7 )\end{matrix}$$

where: u is a pixel taken in the window win^{LP}(p); and
M₁(p) is either D(p) or S(T(p)), and M₂ is the alternate of the two.

The size of the kernel LP is sufficient to account for a limited range of local distortion of the scene depicted by the images. It can be for instance a Gaussian filter whose variance is selected based on the allowable distortion.

An iterative process, such as a gradient descent method, is used to recover the optimal registration parameters. It involves the calculation for each iterative step of the minimum value of Φ′. In the initial step, α=β=1/\sqrt{2} and γ=0. The values α, β, and γ are updated at each iteration.

With the use of the filter kernel presented in FIG. 3, associated to the use of a low pass filter kernel LP, the segmentation method according to the invention is actually based on a successive use of grey level deformation (use of the edge intensity data), and geometric deformation (slowly varying weights α, β, and γ).

In a fifth step 50 of FIG. 1, a composite data image is formed using techniques known in the art. It comprises the reference image and the sensed image, transformed by means of the mapping function T with the use of appropriate interpolation techniques.

This invention also provides an apparatus for registering images comprising pixel data sets of at least two dimensions, and comprising acquisition means to receive an input image D and storage means to store a reference image S, whether acquired beforehand or from a data bank, optional feature detection effectives to provide, e.g. edge-detected images from the input and reference images. The apparatus to the invention further comprises processing effectives to implement the method described hereabove.

This invention may be conveniently implemented using a conventional general-purpose digital computer or microprocessor programmed according to the teachings of the present application.

FIG. 4 is a block diagram of a computer system 300 in accordance to the present invention. Computer system 300 can comprise a CPU (central processing unit) 310, a memory 320, an input device 330, input/output transmission channels 340, and a display device 350. Other devices, as additional disk drives, additional memories, network connections . . . may be included but are not represented.

Memory 320 includes data files containing the sensed and reference images, to be registered. Memory 320 can further include a computer program product, to be executed by the CPU 310. This program comprises instructions to perform the above-described method registering images according to the invention. The input device is used to receive instructions from the user, for example whether to provide or not the edge detected images. Input/output channels can be used to receive the sensed image D to be stored in the memory 320 from an external sensor apparatus, as well as sending the registered image (output image) to other apparatuses. The display device can be used to visualize the output image comprising the registered image generated from the sensed and reference images.

1. An apparatus for registering images comprising data sets of at least two dimensions, the apparatus comprising:
means for obtaining at least a first image and a second image;
means for filtering said first and said second images using a low-pass filter kernel having a sharp central peak and a slow decay away form said central peak; and
means for determining a mapping function that transforms said filtered first image into said filtered second image.

2. The apparatus as claimed in claim 1, wherein said low-pass filter kernel is isotropic and has a substantially sharper peak than an isotropic Gaussian filter kernel having the same effective width as said low-pass filter kernel, and said low-pass filter kernel decreases substantially slower than said Gaussian filter kernel out of the effective width.

3. The apparatus as claimed in claim 2, wherein said low-pass filter kernel has a slope at least three times larger than that of said Gaussian kernel at a distance of W/2 from the origin, and a slope at least three times lower than that of said Gaussian kernel at a distance of 2.W from the origin, where W represents the effective width of said kernels.

4. The apparatus as claimed in claim 1, wherein said low-pass filter kernel behaves substantially like an exponential decay or inverse power law away from the central peak.

5. The apparatus as claimed in claim 1 wherein said low-pass filter kernel is an isotropic filter kernel defined as a sum of Gaussian filters of different variances σ:
$$L ( r ) = {Σ}_{σ} g ( σ ) \cdot \frac{{e}^{- {r}^{2} / {σ}^{2}}}{{σ}^{d}} ,$$
d being the dimension of said first and second images, r being a distance from said filter kernel center, and each Gaussian filter of variance σ being assigned a weight g(σ).

6. The apparatus as claimed in claim 5, wherein each said Gaussian filter of variance a is first applied respectively to said first and second images to generate a first and second multiplicities of individual filtered images, and said first and second filtered images are obtained respectively from a weighted combination of said first and second multiplicities of individual filtered images with said Gaussian filter using said weight g(σ).

7. The apparatus as claimed in claim 1, further comprising means for applying the determined mapping function to said first image to produce a image registered with said second image.

8. The apparatus as claimed in claim 1, wherein the means for obtaining the first and second images comprise means for processing two input images to provide said first and second images as feature-enhanced images based on the two input images.

9. The apparatus as claimed in claim 1, wherein the means for determining the mapping function comprise means for minimizing a dissimilarity criterion defined by the square of a weighted difference between the transformed filtered first image and the filtered second image with slowly varying weights.

10. A medical imaging system, comprising means for acquiring at least two input images depicting body organs, and an apparatus as claimed in claim 1 for registering said images.

11. A method of registering images comprising data sets of at least two dimensions, the method comprising the steps of:
obtaining at least a first image and a second image;
filtering said first and said second images using a low-pass filter kernel having a sharp central peak and a slow decay away form said central peak; and
determining a mapping function that transforms said filtered first image into said filtered second image.

12. The method as claimed in claim 10, wherein said low-pass filter kernel is isotropic and has a substantially sharper peak than a Gaussian filter kernel having the same effective width as said low-pass filter kernel, and said low-pass filter kernel decreases substantially slower than said Gaussian filter kernel out of the effective width.

13. The method as claimed in claim 11, wherein said low-pass filter kernel has a slope at least three times larger than that of said Gaussian kernel at a distance of W/2 from the origin, and a slope at least three times lower than that of said Gaussian kernel at a distance of 2.W from the origin, where W represents the effective width of said kernels.

14. The method as claimed in claim 11, wherein said low-pass filter kernel behaves substantially like an exponential decay or inverse power law away from the central peak.

15. The method as claimed in claim 11, wherein said low-pass filter kernel is an isotropic filter kernel defined as a sum of Gaussian filters of different variances σ:
$$L ( r ) = {Σ}_{σ} g ( σ ) \cdot \frac{{e}^{- {r}^{2} / {σ}^{2}}}{{σ}^{d}} ,$$
d being the dimension of said first and second images, r being a distance from said filter kernel center, and each Gaussian filter of variance σ being assigned a weight g(σ).

16. The method as claimed in claim 11, wherein the step of determining the mapping function comprises minimizing a dissimilarity criterion defined by the square of a weighted difference between the transformed filtered first image and the filtered second image with slowly varying weights.

17. A computer program product, for execution in a processing unit of an image processing apparatus, the computer program product comprising instructions to perform a segmentation method according to claim 11 when the program product is run in the processing unit.
